(19) United States
(12) Patent Application Publication
(10) Pub. No.: US 2010/0238141 A1
(43) Pub. Date: Sep. 23, 2010

(54) PROJECTION DISPLAY APPARATUS, WRITING/DRAWING BOARD, AND PROJECTION SYSTEM

(75) Inventors: Hideyuki Kanayama, Uji-shi (JP); Masashi Oda, Osaka (JP); Yasuo Funazo, Kitakatsuragi-gun (JP); Takehiko Asano, Osaka (JP); Toshiya Iinuma, Souraku-gun (JP); Hidehiro Ugaki, Souraku-gun (JP); Masahiro Sata, Ichinomiya-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/727,777

(22) Filed: Mar. 19, 2010

(30) Foreign Application Priority Data
Mar. 19, 2009 (JP) 2009-068449

(51) Int. Cl. H04N 5/74; G06F 3/033

(52) U.S. Cl. 345/179; 348/759; 348/E05.137

(57) ABSTRACT

A projection system includes a screen, a projection display apparatus for projecting a video image on the screen, and a mount base provided below a projection surface of the screen, for carrying a subject on its upper surface. The projection display apparatus is mechanically coupled to the screen such that video image light from the projection display apparatus is displayed on the screen. Projection display apparatus includes a light source, an imaging portion including the upper surface of the mount base at least in an imaging area, a light modulation portion for modulating light from the light source to generate the video image light based on an input video image or a video image picked up by the imaging portion, and a projection portion for projecting the video image light generated by the light modulation portion.

### BACKGROUND OF THE INVENTION

1. Field of the Invention

The present invention relates to a projection system including a writing/drawing board and a projection display apparatus.

2. Description of the Background Art

Conventionally, a projection display apparatus has subjected a video signal to light modulation by using a light modulation element such as a liquid crystal panel based on a signal output from a reproduction apparatus or an output apparatus outputting a video signal such as a personal computer, and projected the signal from projection means under magnification. Recently, however, owing to wide spread use of a TV conference system or demands in the field of education, various functions have been required in a projection display apparatus.

Under such circumstances, a projector and a camera formed integrally with the projector are provided and an image of a subject located in a direction of imaging by the camera is picked up. Japanese Patent Laying-Open No. 2003-15216 discloses such a projector that a video image of a subject picked up by a camera is sent to the projector and projected by projection means under magnification.

According to the structure described in Japanese Patent Laying-Open No 2003-15216, however, a projector body should be installed at a position optimal for display under magnification, that is, at a distance from a screen on which a video image is to be projected. For example, when a subject 6 is mounted on a table 8 and explanation thereof is given using the screen, a presenter should come and go between the screen and a projector body 2 because the screen and projector body 2 are located away from each other, and smooth explanation could not be given in the presentation.

### SUMMARY OF THE INVENTION

An object of the present invention is to provide a projection display apparatus, a writing/drawing board, and a projection system allowing a presenter to explain contents on a screen while an image of a subject is being picked up without the need for him/her to come and go between the screen and a projector.

A projection system according to one aspect of the present invention includes a screen, a projection display apparatus which projects a video image on the screen, and a mount base provided below a projection surface of the screen, which carries a subject on its upper surface. The projection display apparatus is mechanically coupled to the screen such that video image light from the projection display apparatus is displayed on the screen. The projection display apparatus includes a light source, an imaging portion including the upper surface of the mount base at least in an imaging area, a light modulation portion which modulates light from the light source to generate video image light based on an input video image or a video image picked up by the imaging portion, and a projection portion which projects the video image light generated by the light modulation portion.

Preferably, the screen includes a board body having a projection surface in which writing/drawing with a writing instrument can be made and erased, a frame which holds the board body, and a leg coupled to the frame, which makes the board body stand straight.

Preferably, the projection display apparatus further includes a reflecting mirror which reflects the video image light projected from the projection portion toward the screen.

Preferably, the reflecting mirror bends the video image light projected from the projection portion in a direction at an acute angle with respect to a direction of emission from the projection portion.

Preferably, a direction of imaging and the imaging area of the imaging portion can be changed.

Preferably, the projection display apparatus further includes an entry sensing portion which senses entry of a subject in the imaging area of the imaging portion. The light modulation portion generates video image light based on a video image picked up by the imaging portion when the entry sensing portion sensed entry of the subject.

Preferably, the projection display apparatus further includes a mirror which guides a part of light from the light source to the upper surface of the mount base.

Preferably, a relative position of the mount base can be changed such that its upper surface is in parallel to the screen when it is not used.

Preferably, the projection display apparatus further includes a sensing portion which senses whether the mount base is in use or not, and a control unit which turns on power of the imaging portion when the sensing portion sensed that the mount base is in use.

Preferably, the screen further includes a writing/drawing data processing unit which converts content written or drawn on the projection surface with the writing instrument into writing/drawing data. The projection display apparatus further includes a video signal processing unit which generates video image data for projection by superimposing the writing/drawing data input from the writing/drawing data processing unit on the video image picked up by the imaging portion, and a memory which stores the video image data generated by the video signal processing unit.

A projection display apparatus according to another aspect of the present invention is a projection display apparatus which projects a video image on a screen. The projection display apparatus is structured to mechanically be coupled to the screen such that video image light from the projection display apparatus is displayed on a projection surface of the screen. A mount base which carries a subject on its upper surface is provided below the projection surface of the screen. The projection display apparatus includes a light source, an imaging portion including the upper surface of the mount base at least in an imaging area while the projection display apparatus is coupled to the screen, a light modulation portion which modulates light from the light source to generate video image light based on an input video image or a video image picked up by the imaging portion, and a projection portion which projects the video image light generated by the light modulation portion.

A writing/drawing board according to another aspect of the present invention is a writing/drawing board on which video image light from a projection display apparatus is projected. The writing/drawing board includes a board body having a projection surface in which writing/drawing with a writing instrument can be made and erased, a frame which holds the board body, a plurality of legs coupled to the frame, which make the board body stand straight, a reinforcement portion coupling the plurality of legs to each other, and a mount base fixed to a lower portion of the frame and the reinforcement portion, which carries a subject on its upper surface.

According to such a structure of the present invention, explanation of contents on a screen can be given while an image of a subject is being picked up, without the need for a presenter to come and go between the screen and a projector.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a side view of a projection system according to a first embodiment.

FIG. 2 is a diagram showing a video image light generation portion, a dioptric system, and a reflecting minor according to the first embodiment.

FIGS. 3A and 3B are detailed perspective views of the dioptric system according to the first embodiment.

FIG. 4 is a side view of a projector according to the first embodiment.

FIG. 5 is a block diagram showing a configuration of the projector and a screen according to the first embodiment.

FIG. 6 is a diagram showing a flowchart for causing a camera video image from the projector to be projected on the screen according to the first embodiment.

FIG. 7 is a diagram showing an example of imaging by the camera of the projector according to the first embodiment.

FIG. 8 is a side view showing a structure for illumination of a mount base according to the first embodiment.

FIG. 9 is a perspective view showing a structure for illumination of the mount base according to the first embodiment.

FIG. 10 is a diagram showing an exemplary projected video image according to the first embodiment.

FIG. 11 is a diagram showing a variation of the first embodiment.

FIG. 12 is a perspective view showing the screen formed integrally with the mount base according to the first embodiment.

FIGS. 13A and 13B are diagrams showing states of the mount base in use and not in use according to the first embodiment, respectively.

FIGS. 14A and 14B are enlarged views showing states of the mount base in use and not in use according to the first embodiment, respectively.

FIG. 15 is a block diagram showing a configuration of a projector and a screen according to a second embodiment.

FIG. 16 is a diagram showing an exemplary configuration of the screen according to the second embodiment.

### DESCRIPTION OF THE PREFERRED EMBODIMENTS

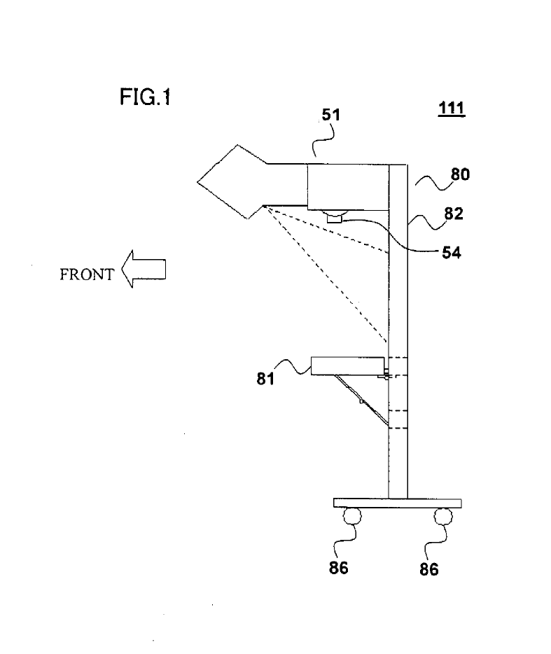

A projection display apparatus according to each embodiment of the present invention will be described hereinafter with reference to FIGS. 1 to 16.

It is noted that the drawings in the present invention are schematic and specific shapes, dimensions or proportions are different. In addition, the drawings may also be different from one another in specific shapes, dimensions or proportions.

Further, the same or similar elements in different figures have the same reference characters allotted and redundant description will not be provided.

### First Embodiment

### Projection System

FIG. 1 is a side view of a projection system 111 according to a first embodiment.

Projection system 111 includes a projector 51 and a writing/drawing board 80.

Projector 51 includes a camera 54 arranged on a lower surface of projector 51.

Writing/drawing board 80 includes a screen 82 having casters 86 arranged in a lower portion and a mount base 81 arranged in front of screen 82.

Camera 54 is arranged in a lower portion of projector 51 and picks up an image of an upper surface of mount base 81. Projector 51 selects a specific input video signal from a plurality of input video signals for projection on screen 82. In addition, projector 51 is capable of projection on screen 82 of the video image picked up by camera 54.

According to such a structure, writing/drawing board 80 and projector 51 can integrally be formed and a smaller size can be achieved. In addition, as writing/drawing board 80 and projector 51 can integrally be formed to achieve a smaller size and casters 86 are provided, projection system 111 is movable. Moreover, as screen 82 and mount base 81 are provided close to each other, for example, a presenter who gives presentation can mount a subject on mount base 81 and give explanation by using a video image projected on screen 82 in the vicinity of projection system 111 according to the invention of the subject application. Therefore, presentation can smoothly proceed.

(Projector Portion)

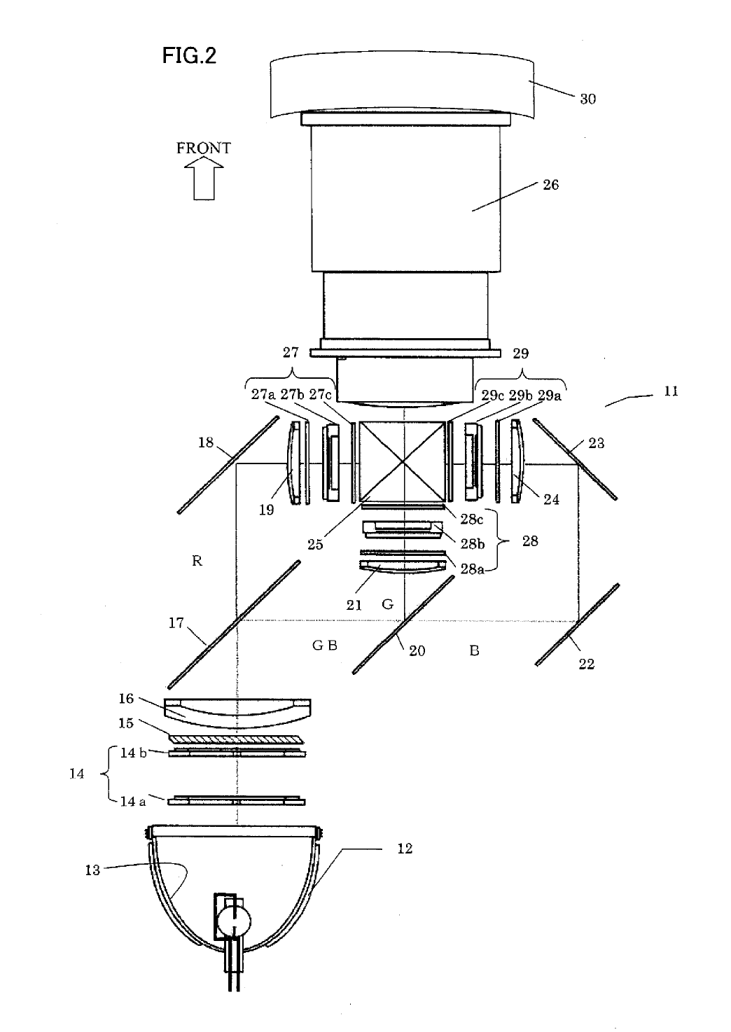

FIG. 2 is a diagram showing a video image light generation portion 11, a dioptric system 26 for projection of a video image generated by video image light generation portion 11, and a reflecting mirror 30, that are used in the first embodiment. A light source 12 is implemented by an extra-high pressure mercury lamp, a metal halide lamp, a xenon lamp, or the like, and light projected therefrom is emitted as collimated light by means of a parabola reflector 13 and guided to an integrator lens 14.

Integrator lens 14 is constituted of a pair of lenses (fry eye lenses) 14a and 14b. Individual lens portion guides light emitted from light source 12 to the entire surface of a light modulation element which will be described later, so that partial luminance unevenness present in light source 12 is averaged and difference in a quantity of light between the center of the screen and a peripheral portion is reduced. Light that has passed through integrator lens 14 passes through a polarization conversion device 15 and a condenser lens 16, and thereafter it is guided to a first dichroic mirror 17. Polarization conversion device 15 is implemented by a polarization beam splitter array (hereinafter referred to as a PBS array). The PBS array includes a polarization split membrane and a phase contrast plate (1/2λ plate). Each polarization split membrane in the PBS array allows passage, for example, of p-polarized light and changes an optical path of s-polarized light by 90 degrees, out of the light from integrator lens 14. The s-polarized light of which optical path was changed is reflected by an adjacent polarization split membrane and emitted as it is. On the other hand, the p-polarized light that has passed through the polarization split membrane is emitted after it is converted to s-polarized light by the phase contrast plate provided in front of the polarization split membrane (on the light emission side). Namely, here, substantially whole light is converted to s-polarized light.

First dichroic mirror 17 allows passage of light in a red wavelength range and reflects light in a cyan (green+blue) wavelength range. The light in the red wavelength range that has passed through first dichroic mirror 17 is reflected by a total reflecting mirror 18 and an optical path thereof is changed. The red light reflected by total reflecting mirror 18 passes through a lens 19 and it is guided to a red-light-transmissive light modulation element 27, which allows passage of the red light and the red light is modulated. On the other hand, the light in the cyan wavelength range reflected by first dichroic mirror 17 is guided to a second dichroic mirror 20.

Second dichroic mirror 20 allows passage of light in a blue wavelength range and reflects light in a green wavelength range. The light in the green wavelength range reflected by second dichroic mirror 20 passes through a lens 21 and it is guided to a green-light-transmissive light modulation element 28, which allows passage of the green light and the green light is modulated. Meanwhile, the light in the blue wavelength range that has passed through second dichroic mirror 20 passes through a total reflecting mirror 22, a total reflecting mirror 23 and a lens 24 and it is guided to a blue-light-transmissive light modulation element 29, which allows passage of the blue light and the blue light is modulated.

Light modulation elements 27, 28 and 29 include incident-side polarization plates 27a, 28a and 29a, panel portions 27b, 28b and 29b formed such that liquid crystals are sealed between a pair of glass substrates (in which a pixel electrode and an orientation film are formed), and emission-side polarization plates 27c, 28c and 29c, respectively.

Modulated light (video image light of each color) modulated as a result of passage through light modulation elements 27, 28 and 29 is combined by a cross dichroic prism 25 to thereby become color video image light. This color video image light is projected toward the front by dioptric system 26 under magnification and projected through reflecting mirror 30 under magnification.

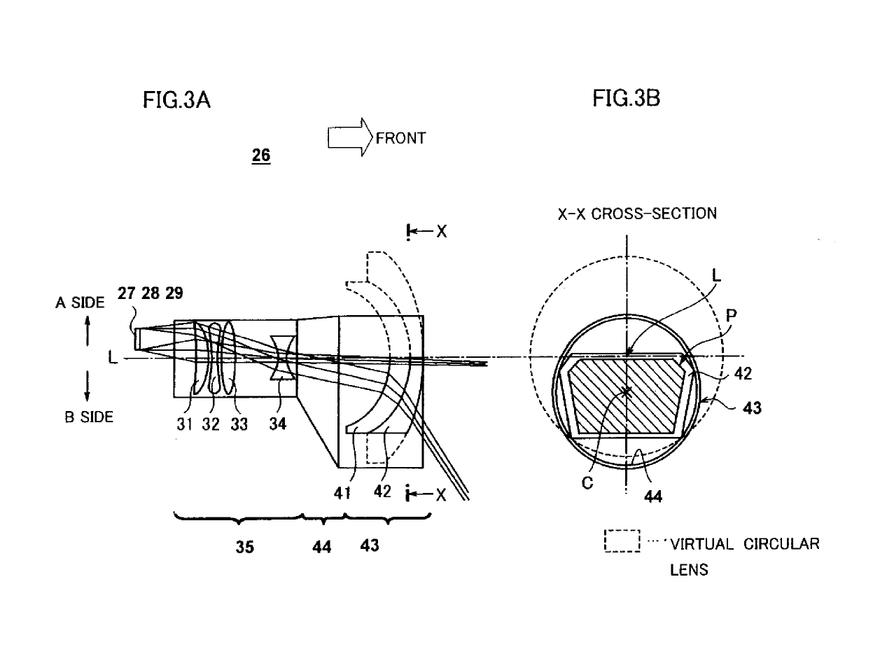

FIG. 3 is a diagram showing dioptric system 26 used in the first embodiment. FIG. 3A is a perspective view of dioptric system 26 when viewed from the side, and FIG. 3B is a cross-sectional view along X-X in FIG. 3A.

Dioptric system 26 magnifies the video image light generated by video image light generation portion 11. Specifically, dioptric system 26 includes a rear housing 35 provided closer to video image light generation portion 11, a front housing 43 provided farther from video image light generation portion 11, and an engagement housing 44 engaging rear housing 35 and front housing 43 with each other.

Rear housing 35 has a cylindrical shape. Namely, rear housing 35 has an annular cross-section. The center of rear housing 35 coincides with an optical axis L of dioptric system 26. Rear housing 35 has a plurality of lenses (lens 31 to lens 34).

Lens 31 to lens 34 are circular lenses. Lens 31 to lens 34 have optical axes coinciding with optical axis L of dioptric system 26. Lens 31 to lens 34 guide light emitted from light modulation elements 27, 28 and 29 provided in the video image light generation portion to front housing 43.

Front housing 43 has a cylindrical shape. Namely, front housing 43 has an annular cross-section. The center of front housing 43 is displaced from optical axis L of dioptric system 26. Front housing 43 has a plurality of lenses (lens 41 and lens 42). As front housing 43 has an annular cross-section, front housing 43 readily rotates and suitably moves lens 41 and lens 42 along the optical axis when zoom is adjusted.

Lenses 41 and 42 in a non-circular shape accommodated in front housing 43 form a part of a lens in a virtually circular shape (hereinafter a virtual circular lens) having optical axis L of dioptric system 26 as the center. The virtual circular lens is greater in diameter than circular lenses accommodated in rear housing 35, for projection of video image light over a wide angle.

A dotted line in FIG. 3 shows the virtual circular lens. The optical axis of the virtual circular lens should coincide with optical axis L of dioptric system 26. Therefore, the center in the cross-section of a virtual front housing coincides with optical axis L of dioptric system 26.

Though description was not provided in connection with FIG. 2, light modulation elements 27, 28 and 29 are shifted toward an A side relative to optical axis L of dioptric system 26. Therefore, lens 31 to lens 34 guide light emitted from light modulation elements 27, 28 and 29 toward a B side relative to optical axis L of dioptric system 26. Thus, light emitted from light modulation elements 27, 28 and 29 is projected in a diagonal direction.

It is noted that the “A side” and the “B side” do not particularly limit up, down, left, and right. Here, the “A side” and the “B side” are merely terms referring to sides opposite to each other, with respect to optical axis L of dioptric system 26.

In the present embodiment, the lens accommodated in front housing 43 is a non-circular lens, however, the embodiment is not limited thereto and a circular lens may be employed.

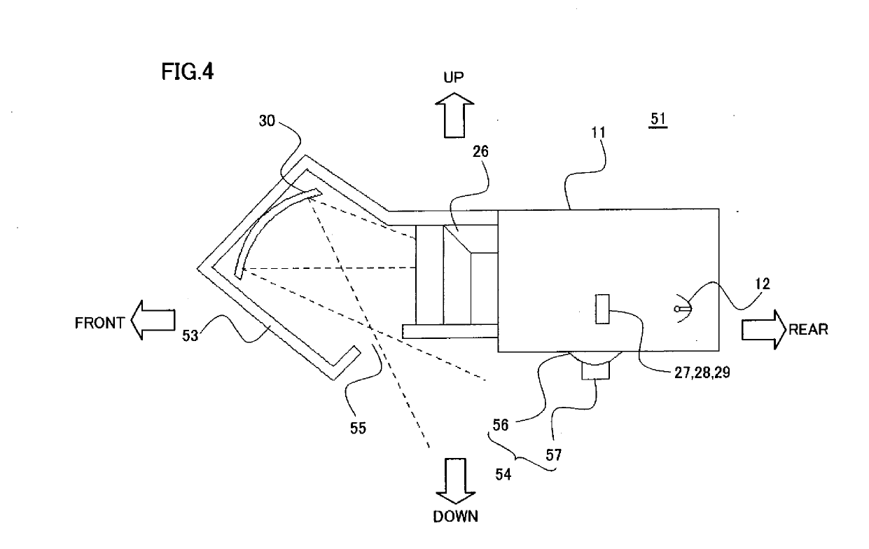

FIG. 4 is a side view of projector 51 representing the projection display apparatus according to the first embodiment. Projector 51 includes video image light generation portion 11, dioptric system 26, reflecting mirror 30, a protection cover 53, and camera 54.

Reflecting mirror 30 reflects video image light emitted from video image light generation portion 11 by bending that video image light in a direction at an acute angle with respect to a direction of emission from dioptric system 26. In addition, the reflected light is guided to a transmissive region 55 while converging. For example, reflecting mirror 30 is an aspherical mirror having a concave surface on video image light generation portion 11 side. Transmissive region 55 is preferably arranged at a position of reflecting mirror 30 where light is condensed most, in order to achieve narrower transmissive region 55.

Protection cover 53 is a cover for protecting reflecting mirror 30. Protection cover 53 is provided in order to secure a back surface of reflecting mirror 30 and to protect reflecting mirror 30 against dust or the like. Protection cover 53 covers the back surface of reflecting mirror 30 and has transmissive region 55 allowing passage of video image light.

Camera 54 includes a dome-shaped fixing portion 56, an objective lens 57, and a not-shown imaging element. Objective lens 57 is provided on dome-shaped fixing portion 56 and forms an image of imaging light on an imaging element while converging the imaging light. The imaging element converts imaging light condensed by objective lens 57 to an electrical signal and takes in the same as imaging data. In addition, camera 54 is arranged on the lower surface of video image light generation portion 11 such that it is positioned to be able to photograph mount base 81, as will be described later.

It is noted that it is not necessary to fix a direction of photographing by camera 54, and such a structure that camera 54 moves along a spherical surface of dome-shaped fixing portion 56 automatically or through a user's operation may be employed.

Not only mount base 81 but also contents on a screen, a person who views a video image, and the like can thus be taken in as imaging data.

Moreover, though camera 54 is arranged on the lower surface of video image light generation portion 11, camera 54 may be arranged inside projector 51 and imaging light may be taken in through transmissive region 55.

Then, no direct impact is applied to camera 54 and good appearance is maintained.

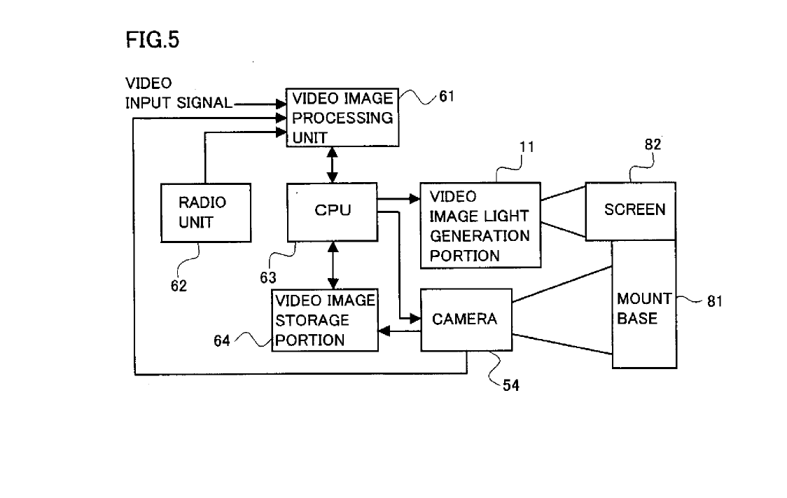

FIG. 5 is a block diagram showing a configuration of projector 51 according to the first embodiment.

A video image processing unit 61 adjusts an aspect ratio or adjust resolution of a video image preferred for projection by projector 51 when a video input signal from a personal computer, a reproduction apparatus or the like or a video input signal from equipment wirelessly connected to a radio unit 62 is input thereto. In addition, when no video image is input to video image processing unit 61, a signal to that effect is transmitted to a CPU 63. When a video image is input, the signal subjected to video image processing is sent to video image light generation portion 11 through CPU 63 so that the video image is projected on screen 82.

CPU 63 reads a logo video image or a blue back video image stored in advance in video image processing unit 61 based on a signal indicating that no video image from video image processing unit 61 is input, and causes video image light generation portion 11 to project a logo video image or a blue back video image on screen 82. In addition, CPU 63 turns on camera 54 upon reception of a signal indicating turn-on of camera 54 which will be described later.

Camera 54 can pick up an image of an object mounted on mount base 81 and transmit imaging data to a video image storage portion 64 and video image processing unit 61.

In transmission of imaging data from camera 54 to video image processing unit 61 for video image processing, when a video input signal or a video image from radio unit 62 is present, it may be displayed together with imaging data from camera 54 in accordance with PIP (Picture in Picture) or PBP (Picture by Picture).

In addition, as radio unit 62 of projector 51 is capable of wireless reception, projection system 111 can be used regardless of a location where external equipment such as a personal computer, a reproduction apparatus or the like is installed or a location where a communication cable can be used.

(Control Flow of Camera)

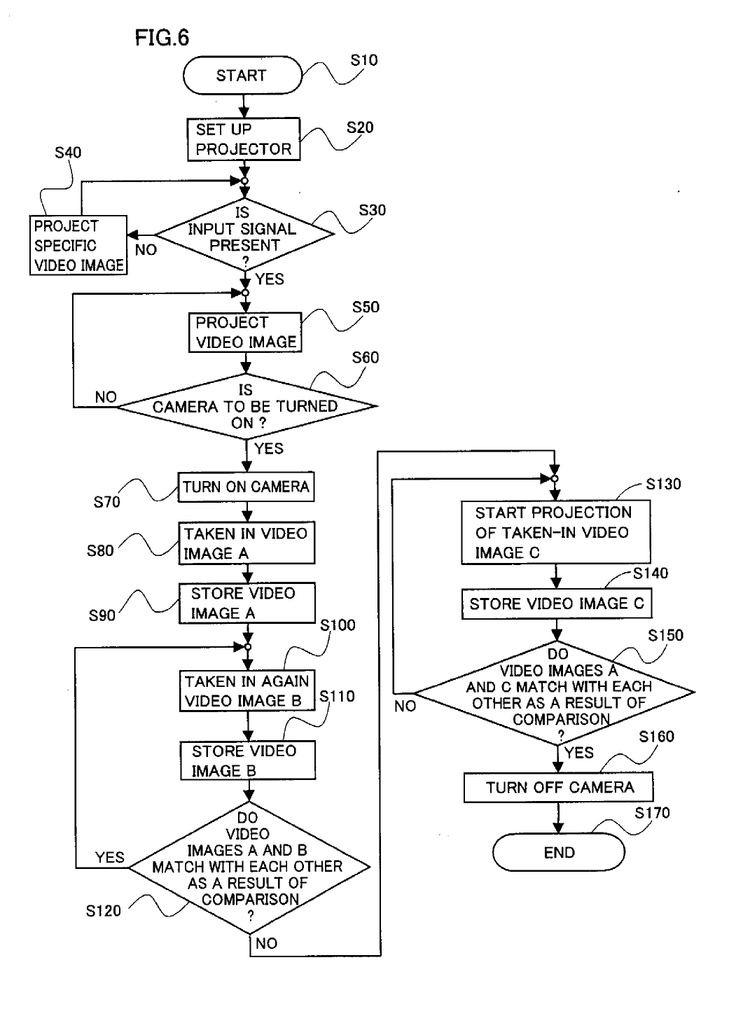

FIG. 6 is a flowchart showing a control method for causing a video image obtained by camera 54 to be projected on screen 82 using projector 51 according to the first embodiment.

Initially, power of projector 51 is turned on (S10), so as to set up video image projection by setting up light source 12 necessary for projection by projector 51 and setting up a not-shown control circuit (S20).

In S30, whether a video input signal is present or not is determined. When no video input signal is present (No in S30), a logo or a blue back video image stored in advance in video image storage portion 64 is projected (S40) and whether a video input signal is present or not is determined again (S30). When a video input signal is present (Yes in S30), projector 51 projects a video image as a projection video image based on the video input signal (S50).

In S60, whether to turn on camera 54 or not in accordance with a method of turning on camera 54 for picking up an image of mount base 81 which will be described later is determined. When camera 54 is not to be turned on (No in S60), a video image is successively projected based on the video input signal (S50). When the camera is to be turned on (Yes in S60), power of camera 54 is turned on (S70).

In S80, camera 54 takes in a video image A of mount base 81.

In S90, video image A taken in by camera 54 is stored in video image storage portion 64.

In S100, camera 54 again takes in a video image B of mount base 81 every prescribed period.

In S110, video image B taken in by camera 54 is stored in video image storage portion 64.

In S120, taken-in video image A and video image B are compared with each other. When these video images match with each other (Yes in S120), it is determined that no object of which image is to be picked up is mounted on mount base 81 and camera 54 again takes in video image B of mount base 81 until an object of which image is to be picked up is mounted on mount base 81 (S100). When taken-in video image A and video image B are compared with each other and these video images do not match with each other (No in S120), it is determined that an object of which image is to be picked up has been mounted on mount base 81 and a video image C taken in by camera 54 is successively projected (S130). It is noted that video image C may be a motion picture.

In S140, video image C taken in by camera 54 is stored in video image storage portion 64.

In S150, taken-in video image A and video image C are compared with each other. When these video images do not match with each other (No in S150), it is determined that a state that an object of which image is to be picked up is mounted on mount base 81 is maintained and video image C taken in by camera 54 is successively projected (S130). When taken-in video image A and video image C are compared with each other and these video images match with each other (Yes in S150), it is determined that an object of which image is to be picked up has been removed from mount base 81, power of camera 54 is turned off (S160), and projection of a video image picked up by camera 54 ends (S170).

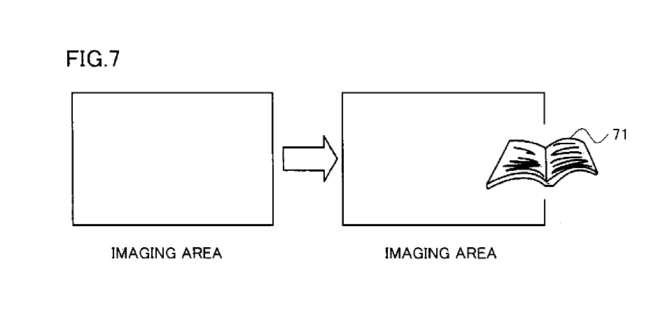

According to such a control method for causing projector 51 to project a video image taken by camera 54, as shown in FIG. 7, as a subject 71 enters an imaging area on mount base 81, a video image picked up by camera 54 can be projected on screen 82.

In addition, a state of a surface of mount base 81 at the time when a user uses mount base 81 can be stored as an initial video image. Therefore, even though mount base 81 is damaged or gets dirty through use by the user and a state of mount base 81 is not as good as new, mount base 81 that has been damaged or has got dirty can be stored as an initial video image. Thus, even when the user decorates mount base 81 at his/her pleasure for example, the imaging operation as above can still be performed.

(Structure for Illumination)

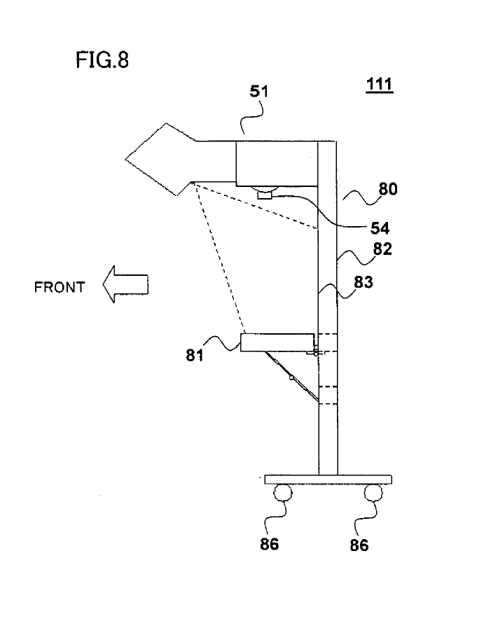

A structure for illumination for illuminating mount base 81 will be described hereinafter in detail with reference to FIGS. 8 to 11.

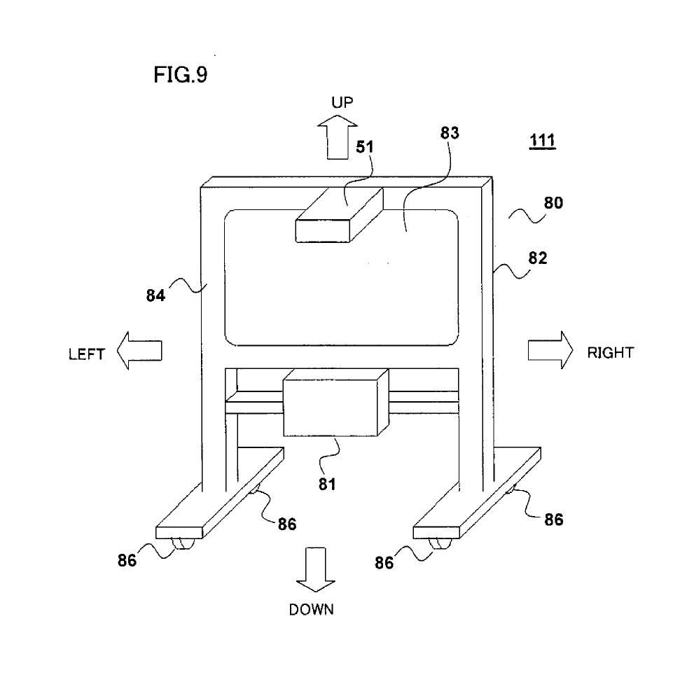

FIG. 8 shows a side view of projection system 111 in the first embodiment. In addition, FIG. 9 shows a perspective view of projection system 111 in the first embodiment.

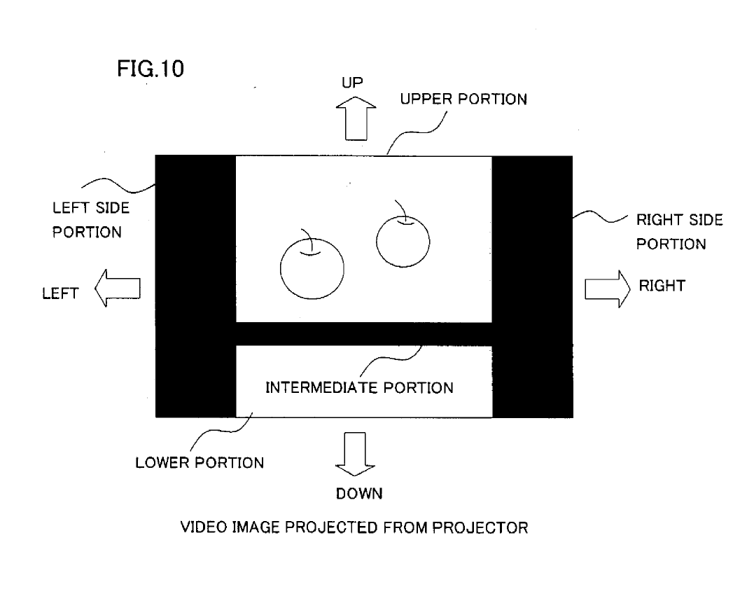

Projection light projected from projector 51 is projected not only onto a whiteboard 83 but also onto the entire surface of mount base 81. As shown in FIG. 10, a video image from projector 51 is projected, as divided into a left side portion, a right side portion, an upper portion, an intermediate portion, and a lower portion. Black video images are projected as video images for the left side portion and the right side portion. A video image based on a video input signal is projected as the video image for the upper portion. A black video image is projected as the video image for the intermediate portion. A white video image is projected as the video image for the lower portion.

Here, the video image for the upper portion based on the video input signal is projected on whiteboard 83, a black video image which is the video image for the intermediate portion is projected in a lower portion of a whiteboard frame 84, and a white video image which is the video image for the lower portion is projected on mount base 81.

According to such a structure, not only a desired video image is projected on whiteboard 83 but also white light serving as illumination light is projected onto mount base 81. Therefore, subject 71 is illuminated brightly with light when it is mounted and an image of subject 71 can be picked up by camera 54 as a bright video image.

(Variation of Illumination)

A variation of the structure for illumination for illuminating mount base 81 will be described hereinafter in detail.

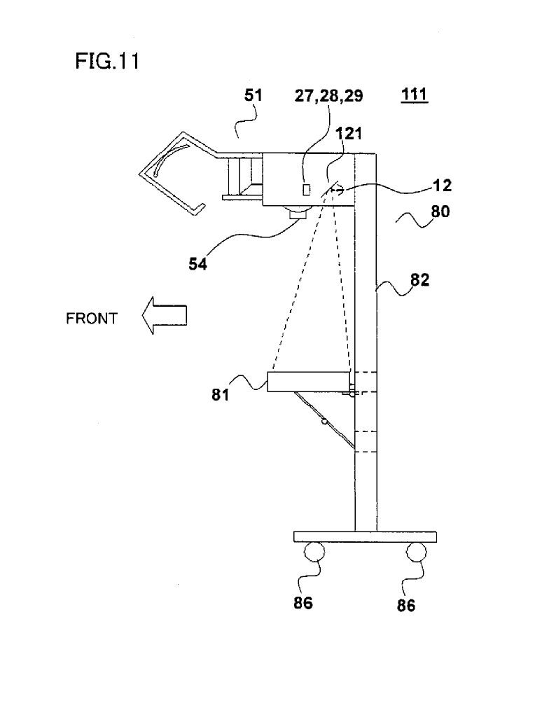

FIG. 11 shows a side view of projection system 111 according to the variation of the first embodiment. A part of projection light projected from light source 12 is projected onto the entire surface of mount base 81.

In front of light source 12 arranged in video image light generation portion 11 of projector 51, a half mirror 121 capable of reflecting a part of incident light (for example, transmitted light:reflected light=95:5) is arranged.

Half mirror 121 is arranged to guide a part of light projected from light source 12 onto mount base 81.

According to such a structure, as in the first embodiment, not only a desired video image is projected on whiteboard 83 but also white light serving as illumination light is projected onto mount base 81. Therefore, subject 71 is illuminated brightly with light when it is mounted and an image of subject 71 can be picked up by camera 54 as a bright video image. In addition, since it is not necessary to project the video images for the left side portion, the right side portion and the intermediate portion as black video images as in the first embodiment, light utilization efficiency can be improved.

Though not shown, screen 82 and projector 51 are electrically connected to each other through a connector or the like, and projector 51 may be structured such that it is removably connected to screen 82.

Projection system 111 according to the first embodiment is structured such that projector 51 is fixed to the upper portion of screen 82 integrally formed with mount base 81. A location where projector 51 is to be fixed, however, is not limited to the upper portion of screen 82, and it may be fixed to a left or right portion of screen 82. Alternatively, a separate structure having high rigidity may be arranged on either left or right of screen 82 such that projector 51 is fixed to the separate structure.

The description to the effect that such a structure that a direction of photographing by camera 54 is not fixed but camera 54 moves along a spherical surface of the dome-shaped fixing portion automatically or through a user's operation may be employed has been given. Imaging, however, may be carried out by setting a direction of photographing by camera 54 to a direction of whiteboard 83 and data obtained by imaging of whiteboard 83 may be stored in video image storage portion 64. When power is turned off, an image of whiteboard frame 84 may automatically be picked up and imaging data may be stored in video image storage portion 64.

Though the embodiment shows a projection display apparatus including a transmissive-type light modulation element, the embodiment is not limited thereto and the present invention is applicable also to a projection display apparatus including another video image light generation system. The present invention is also applicable to a DMD (Digital Mirror Device) scheme, an LCOS (Liquid Crystal on Silicon) scheme, and a solid-state light source scheme using a solid-state light source such as laser beams.

(Structure of Screen)

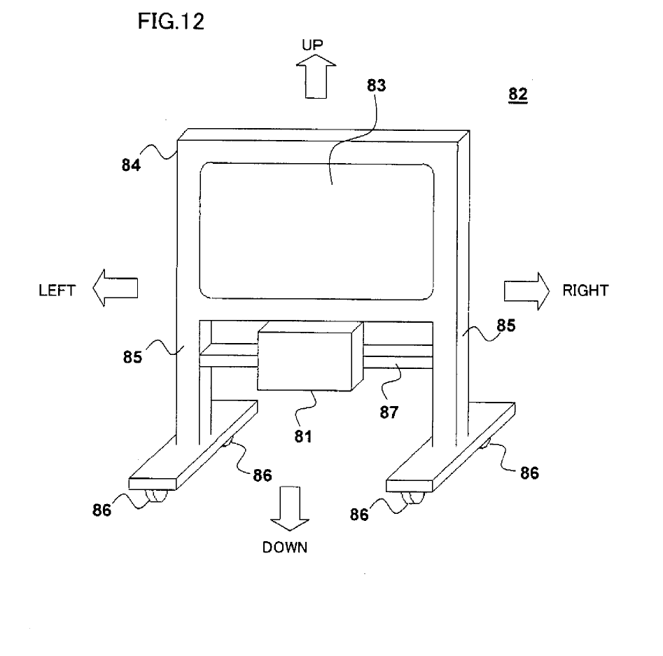

FIG. 12 is a perspective view showing screen 82 formed integrally with mount base 81 in the first embodiment.

Screen 82 includes whiteboard 83, whiteboard frame 84, a support leg 85, caster 86, a support bar 87, and mount base 81.

Whiteboard 83 has a substantially rectangular white flat surface, on which a character, graphics or the like can be written or drawn with a not-shown whiteboard marker and from which a character, graphics or the like written or drawn with the whiteboard marker can be erased with a not-shown whiteboard eraser. In addition, since whiteboard 83 has a white flat surface, it is suitable for showing a video image projected from a projector or the like.

Whiteboard frame 84 is formed to cover four sides of whiteboard 83 and whiteboard 83 is fitted into whiteboard frame 84 such that it does not readily fall off from whiteboard frame 84.

Support legs 85 are formed to extend vertically downward from left and right lower ends of whiteboard frame 84 respectively, and a portion thereof in the vicinity of the ground is formed to extend horizontally to the ground such that whiteboard 83 and whiteboard frame 84 are not overturned. Therefore, support leg 85 forms an inverted T-shape when viewed from the side of screen 82. In addition, caster 86 is provided on the surface in contact with the ground, of support leg 85 formed to extend horizontally to the ground. Thus, as caster 86 rolls when screen 82 is moved, a location where screen 82 is installed can readily be changed.

Support bar 87 is formed perpendicularly to support legs 85 and connected thereto, so that it serves as a reinforcement member for supporting support legs 85.

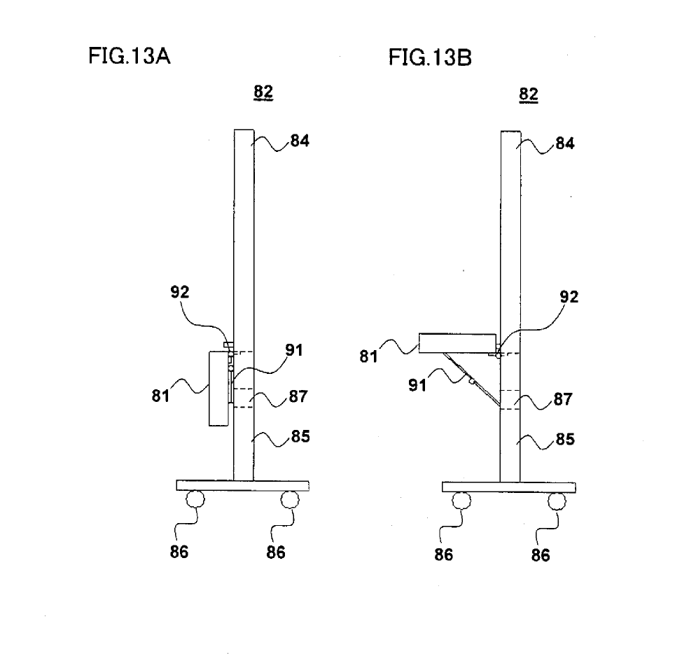

Mount base 81 will be described in detail with reference to FIGS. 13A and 13B. FIGS. 13A and 13B are side views of screen 82 in the first embodiment FIG. 13A shows a view of folded mount base 81 in a state not in use. FIG. 13B shows a view of mount base 81 in a state in use where mount base 81 is set in parallel to the ground and fixed with a fixing device 91.

Fixing device 91 fixed to mount base 81 has one end fixed in the vicinity of a tip end of mount base 81 and the other end fixed to support bar 87. In addition, a hinge 92 fixed to mount base 81 has one end fixed in the vicinity of a terminal end of mount base 81 and the other end fixed to a lower end surface of whiteboard frame 84.

When mount base 81 is not in use, mount base 81 is accommodated such that it is in parallel to whiteboard 83 surface with fixing device 91 and hinge 92 being folded. Alternatively, when mount base 81 is in use, a tip end portion of mount base 81 is pulled out from the state not in use and mount base 81 is held such that it extends perpendicularly to support leg 85, by means of a not-shown locking mechanism of fixing device 91.

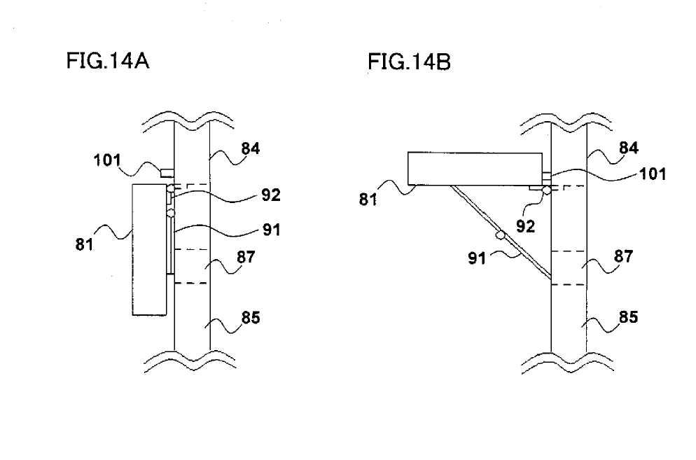

FIGS. 14A and 14B are enlarged views of mount base 81 when screen 82 in the first embodiment is viewed from the side. FIG. 14A shows a view of folded mount base 81 in a state not in use. FIG. 14B shows a view of mount base 81 in a state in use where mount base 81 is set in parallel to the ground and fixed with fixing device 91. A method of detecting whether mount base 81 is in use or not will be described hereinafter in detail.

A detection switch 101 is formed to project from a front surface in the center of a lower portion of whiteboard frame 84. Detection switch 101 can be pressed in a direction perpendicular to whiteboard frame 84. When external force is not applied in particular, detection switch 101 is maintained in a most projecting state owing to a not-shown elastic body. As detection switch 101 is pressed, a pressed state can be detected.

When mount base 81 is not in use as folded as shown in FIG. 14A, detection switch 101 is not pressed. On the other hand, when mount base 81 is set in parallel to the ground as shown in FIG. 14B, detection switch 101 is pressed. Thus, whether mount base 81 is in use or not can be detected.

According to such a structure, detection switch 101 is pressed when mount base 81 is set in parallel to the ground. For example, by causing detection switch 101 and camera 54 to operate in coordination, camera 54 can be turned on when mount base 81 is actually used, which makes handling convenient. In addition, since it is not necessary to needlessly turn on camera 54, electric power consumed by camera 54 can be reduced and longer life can be achieved.

### Second Embodiment

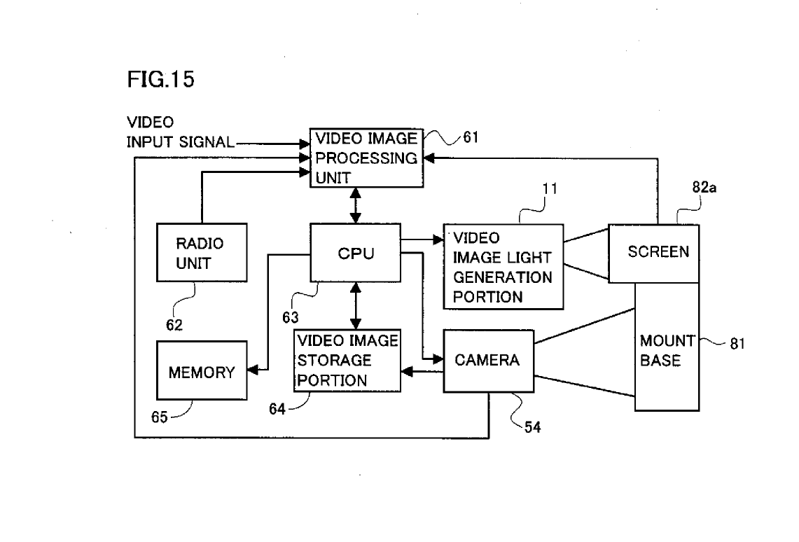

A structure of a projection display apparatus according to a second embodiment will be described hereinafter with reference to the drawings. It is noted that description of the second embodiment common to the first embodiment will not be provided. FIG. 15 is a block diagram showing a configuration of projector 51 according to the second embodiment.

Attention should be paid to the fact that the second embodiment is significantly different from the first embodiment in that contents on a screen 82a written or drawn with a whiteboard marker can be output to video image processing unit 61 of projector 51, which in turn can be superimposed on imaging data obtained by camera 54, and the resultant data can be stored in a memory 65.

An image of the upper surface of mount base 81 is picked up by camera 54 and the imaging data is projected on screen 82a through video image light generation portion 11 via video image processing unit 61 and CPU 63. Thus, the user can write a character or draw graphics on screen 82a with a whiteboard marker while viewing a video image of the upper surface of mount base 81. Writing/drawing data is input to CPU 63 through video image processing unit 61 of projector 51 from screen 82a (which will be described later). CPU 63 can superimpose the imaging data of the upper surface of mount base 81 on the writing/drawing data on screen 82a, and cause memory 65 to store data obtained by superimposing the imaging data and the writing/drawing data on each other in response to a user's command or the like.

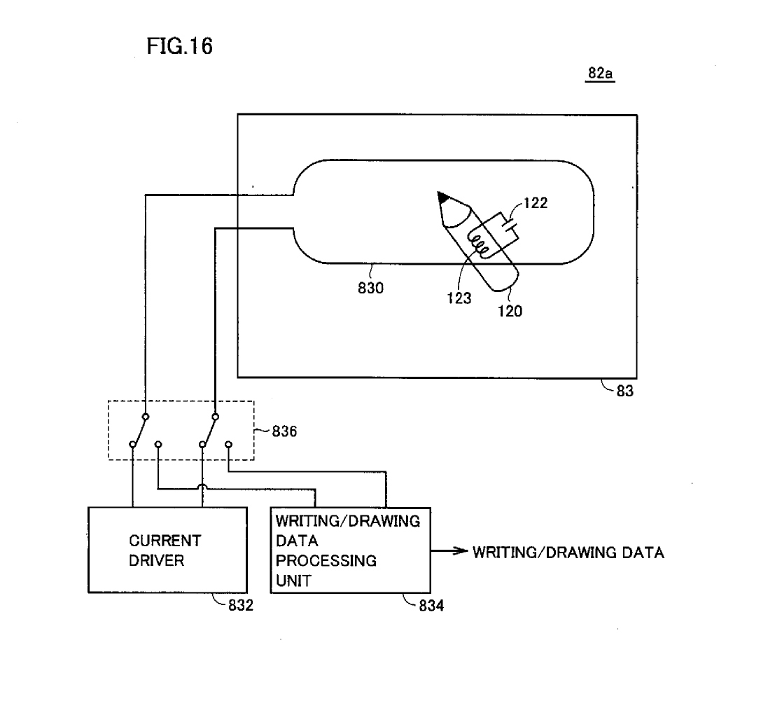

Screen 82a and the whiteboard marker used in the second embodiment will be described hereinafter. FIG. 16 is a diagram showing an exemplary configuration of screen 82a according to the second embodiment.

Referring to FIG. 16, screen 82a includes whiteboard 83, a current driver 832, a writing/drawing data processing unit 834, and a switch 836.

The surface of whiteboard 83 is covered with a reinforcing melanin resin. Wires 830 run in matrix within whiteboard 83.

Switch 836 alternately switches, at specific interval, between a state that wire 830 and current driver 832 are electrically connected to each other and a state that wire 830 and writing/drawing data processing unit 834 are electrically connected to each other.

While current driver 832 and wire 830 are connected to each other by switch 836, current driver 832 supplies an AC current to wire 830. When writing/drawing data processing unit 834 is electrically connected to wire 830 by switch 836, it senses a current that flows through wire 830.

A whiteboard marker 120 used for writing or drawing on whiteboard 83 includes a coil 123 and a capacitor 122 connected to coil 123. Coil 123 is embedded in a tip end portion of whiteboard marker 120.

When the tip end portion of whiteboard marker 120 is located close to the surface of whiteboard 83 while current driver 832 supplies an AC current to wire 830, an induced current is generated in coil 123 of whiteboard marker 120. Therefore, charges are accumulated in capacitor 122 connected to coil 123.

Then, when supply of the AC current to wire 830 is stopped as a result of switching of switch 836, charges accumulated in capacitor 122 flow to coil 123. Here, the induced current flows through wire 830 at a position where the tip end portion of whiteboard marker 120 is located.

Writing/drawing data processing unit 834 senses the induced current that flows through wire 830. Writing/drawing data processing unit 834 can specify at which position on whiteboard 83 whiteboard marker 120 is located, based on the sensed induced current.

Since ON/OFF of an AC current that flows through wire 830 is repeated by means of switch 836 at specific interval, a position of whiteboard marker 120 on whiteboard 83 can be detected at specific interval. Therefore, as the user moves whiteboard marker 120 over screen 82a, writing/drawing data processing unit 834 can obtain this trace of whiteboard marker 120 as data of a character, graphics or the like. This data is output to video image processing unit 61 of projector 51 as the writing/drawing data.

Video image processing unit 61 of projector 51 superimposes the writing/drawing data indicating contents written or drawn on screen 82a on the imaging data obtained through imaging of the upper surface of mount base 81 in response to an instruction from CPU 63, to thereby generate video image data for projection. CPU 63 causes video image light generation portion 11 to project the generated video image data on screen 82a. Thus, a character, graphics or the like can be written or drawn even if a whiteboard marker does not contain ink.

In addition, CPU 63 can cause memory 65 to store data generated by superimposition of the writing/drawing data on the imaging data in response to a user's command or the like.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A projection system, comprising:
a screen;
a projection display apparatus which projects a video image on said screen; and
a mount base provided below a projection surface of said screen, which carries a subject on its upper surface,
said projection display apparatus being mechanically coupled to said screen such that video image light from said projection display apparatus is displayed on said screen, and
said projection display apparatus including
a light source,
an imaging portion including the upper surface of said mount base at least in an imaging area,
a light modulation portion which modulates light from said light source to generate video image light based on an input video image or a video image picked up by said imaging portion, and
a projection portion which projects the video image light generated by said light modulation portion.

2. The projection system according to claim 1, wherein
said screen includes
a board body having a projection surface in which writing/drawing with a writing instrument can be made and erased,
a frame which holds said board body, and
a leg coupled to said frame, which makes said board body stand straight.

3. The projection system according to claim 1, wherein
said projection display apparatus further includes a reflecting mirror which reflects the video image light projected from said projection portion toward said screen.

4. The projection system according to claim 3, wherein
said reflecting mirror bends the video image light projected from said projection portion in a direction at an acute angle with respect to a direction of emission from said projection portion.

5. The projection system according to claim 1, wherein
a direction of imaging and the imaging area of said imaging portion can be changed.

6. The projection system according to claim 1, wherein
said projection display apparatus further includes an entry sensing portion which senses entry of a subject in the imaging area of said imaging portion, and
said light modulation portion generates video image light based on a video image picked up by said imaging portion when said entry sensing portion sensed entry of the subject.

7. The projection system according to claim 1, wherein
said projection display apparatus further includes a mirror which guides a part of light from said light source to the upper surface of said mount base.

8. The projection system according to claim 1, wherein
a relative position of said mount base can be changed such that its upper surface is in parallel to said screen when it is not used.

9. The projection system according to claim 8, wherein
said projection display apparatus further includes
a sensing portion which senses whether said mount base is in use, and
a control unit which turns on power of said imaging portion when said sensing portion sensed that said mount base is in use.

10. The projection system according to claim 1, wherein
said screen further includes a writing/drawing data processing unit which converts content written or drawn on said projection surface with said writing instrument into writing/drawing data, and
said projection display apparatus further includes
a video signal processing unit which generates video image data for projection by superimposing said writing/drawing data input from said writing/drawing data processing unit on the video image picked up by said imaging portion, and
a memory which stores said video image data generated by said video signal processing unit.

11. A projection display apparatus which projects a video image on a screen, structured to mechanically be coupled to said screen such that video image light from said projection display apparatus is displayed on a projection surface of said screen, a mount base which carries a subject on its upper surface being provided below the projection surface of said screen, comprising:
a light source;
an imaging portion including the upper surface of said mount base at least in an imaging area while the projection display apparatus is coupled to said screen;
a light modulation portion which modulates light from said light source to generate video image light based on an input video image or a video image picked up by said imaging portion, and
a projection portion which projects the video image light generated by said light modulation portion.

12. A writing/drawing board on which video image light from a projection display apparatus is projected, comprising:
a board body having a projection surface in which writing/drawing with a writing instrument can be made and erased;
a frame which holds said board body;
a plurality of legs coupled to said frame, which make said board body stand straight;
a reinforcement portion coupling said plurality of legs to each other; and
a mount base fixed to a lower portion of said frame and said reinforcement portion, which carries a subject on its upper surface.
